(19) United States
(12) Patent Application Publication
(10) Pub. No.: US 2005/0177612 A1
(43) Pub. Date: Aug. 11, 2005

(54) System and method for dynamically quiescing applications

(76) Inventor: Chi Duong, Grand Rapids, MI (US)

Correspondence Address: BRINKS HOFER GILSON & LIONE, P.O. BOX 10395, CHICAGO, IL, 60610, US

(21) Appl. No.: 10/754,932

(22) Filed: Jan. 8, 2004

(51) Int. Cl. G06F 15/16

(52) U.S. Cl. 709/200

(57) ABSTRACT

A method and system for dynamically quiescing applications in which the response time of a back end is measured and a front end application is disabled if the back end response time is too long and a sufficient number of instances of non-responsiveness have occurred in a given period. The front end application is disabled to prevent non-responsiveness and potential crashing of the web server, and then is reenabled (unquiesced) after a period of time.

### BACKGROUND

To provide information to users or conduct commerce over the internet, or other network connections, servers are employed to send and gather information from a user's computer. A user's computer, known as a client, may requests information from another computer, known as a server. In a multi-tier environment, the server may comprise a front-end portion that provides a web application and interfaces with a back-end portion that accesses a database to provide the requested information.

Clients send requests to the front end of the server by transmitting one or more packets of data. The front end receives the packets, decodes the information, and responds to the client request by transmitting one or more packets of data back to the client. If the client request requires information from the backend, the front end will gather the information from the back end and provide that information to the client, if the client is authorized to receive the information.

Ideally, the server would provide no appreciable delay in responding to the request of the client. Yet, delays may occur, such as due to network congestion. Delay may also occur due to a lack of responsiveness by internal processes running in the server environment.

Responding to a client request requires that the server perform a process. A process is a software service that performs a certain function. The functionality of the process is performed by one or more threads. Threads are chains of instructions, which are executed independently or in conjunction with one another. The server typically has a limited processing capacity that limits the number of threads available at any given time.

If the back end is slow in its response, all of the available threads for the front end may eventually be tied up waiting for responses. For example, in a Microsoft® IIS 4.0 web server application, the front end may be limited to 30 threads. When all the threads are tied up waiting for a response and incoming requests from the web exceed certain limits, the front end web server will stop responding to requests or, in a worst case, crash. This may necessitate manual intervention to restore the server back to normal operating status. Further, if a first-come-first out serve queuing programming model is employed in the backend, response time will be poor even if the web server does not crash because all requests are processed sequentially (i.e. a newer request must wait until all previous requests have been processed). This also reduces the capacity of the servers to serve other clients and more hardware will be needed in order to serve more clients.

### BRIEF DESCRIPTION OF THE DRAWINGS

FIG. 1 is a block diagram of an exemplary communications network setup including a plurality of clients which communicate with a server environment via the network.

FIG. 2 depicts a flow chart showing dynamic quiescing of an application according to one embodiment for use with the server depicted in FIG. 1.

FIG. 3 depicts a flow chart generally showing unquiescing of an application according to one embodiment for use with the server depicted in FIG. 1.

FIG. 4 depicts a flow chart showing the operation of the middleware in evaluating the ability to provide a response to a user according to one embodiment for use with the server depicted in FIG. 1.

### DETAILED DESCRIPTION OF THE DRAWINGS AND THE DISCLOSED EMBODIMIENTS

The disclosed embodiments relate to a system and method of dynamically quiescing (disabling) and unquiescing (enabling) applications. Although the preferred embodiments are directed towards a client-server relationship where the Internet forms the mode of communication between the server and the client, any publicly or privately accessible wide area network (WAN) or local area network (LAN) configuration, or combination thereof, may be used. Further, the disclosed embodiments may be used with other computer-program-to-computer-program relationships besides client-server, such as master/slave or peer-to-peer, via networked or non-networked modes of communication, including tightly or loosely coupled multiprocessor based systems.

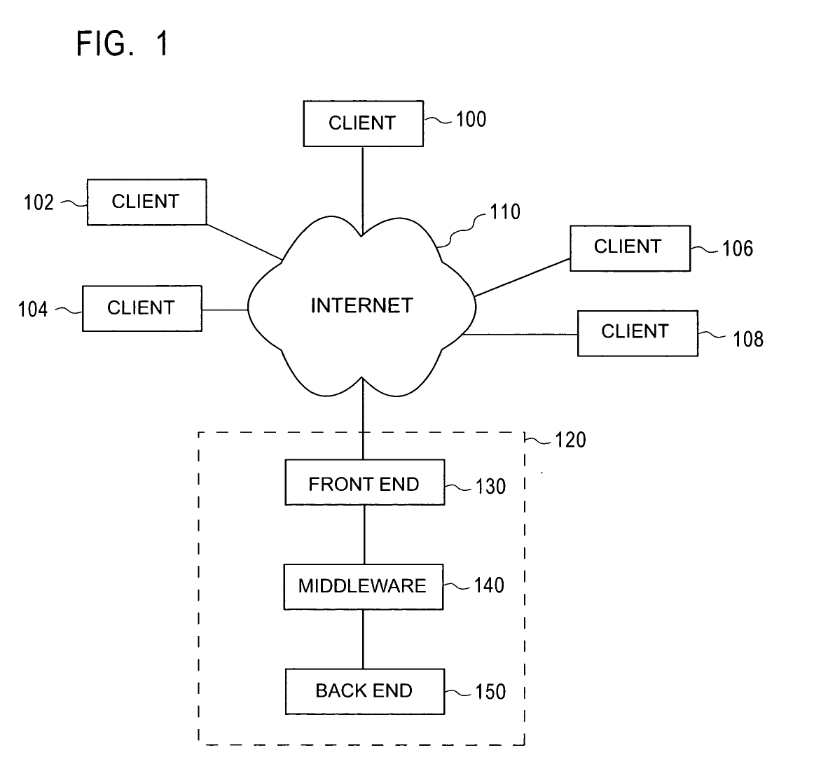

FIG. 1 shows a typical arrangement in which a plurality of clients 100, 102, 104, 106, and 108 are connected to the internet 110. The server environment 120 is also connected to the internet. In one embodiment, the server environment 120 consists of a front end 130, middleware 140, and a back end 150 coupled together. Herein, the phrase “coupled with” is defined to mean directly connected to or indirectly connected through one or more intermediate components. Such intermediate components may include both hardware and software based components. In this embodiment, the front end 130, middleware 140, and a back end 150 reside in separate computers and are connected by way of a WAN or LAN configuration, including one or more Internet connections. In a typical setup, front end 130, middleware 140, and a back end 150 each employ a farm of servers independently for scalability. In an alternative environment, they may all reside on one computer.

In a larger configuration, the server environment 120 may employ one or more additional middleware portions that reside between the front end and the back end. In a even larger configuration, the server environment 120 may consist of 100 web servers acting as a front end 130, 10 application servers acting as middleware 140, and 1 or 2 databases or mainframes acting as a back end 150. Queuing may be employed extensively in a server environment to provide a more robust system.

In one embodiment, the front end 130 is a Microsoft® IIS web server operating on a PC running Microsoft Windows 2000. The web server runs active server page (ASP) scripts. In this embodiment, the middleware 140 is an application server that runs on PC running Microsoft Windows 2000. The middleware communicates with the front end using Microsoft® DCOM communication protocol. In the alternative, if the front end and middleware are run in a single computer, the Microsoft® COM components are utilized. In this embodiment, the middleware uses the visual basic programming language to implement the DCOM components. In the alternative, C++ or any other programming language may be used to provide DCOM or COM components. In yet further alternative embodiments, the front end may run java server pages (JSP) and the middleware may run servlet and java bean components.

The back end hosts a database and all the functionality related to it. In this embodiment, the back end is comprised of an IBM AS400 system and a mainframe that each contain databases using IBM legacy code. In the alternative, the back end can utilize other types of databases, such as an Oracle database or Microsoft® SQL server. Additionally, other functions may be implemented at the back end. For example, alternative embodiments may incorporate a back end in which specialized processing performs a complex task, such as mathematical computations, that would overburden a client computer.

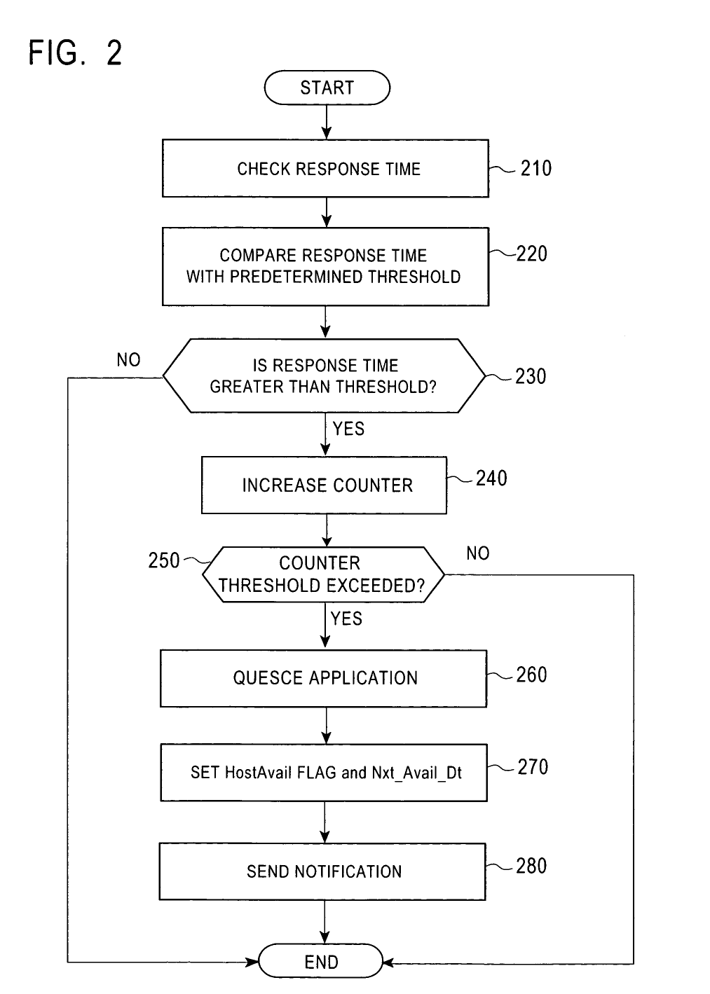

If the load on the back end provides an inadequate response time, the back end may bottleneck the server environment (and thus the clients as well). To prevent diminished responsiveness or potential crashes of the front end, it is desirable to suspend an application operating on the front end if the back end is unable to provide a response in a reasonable amount of time. According to one embodiment, when the front end 130 receives a request from a client, the middleware 140 will evaluate whether the application should be disabled (known as quiescing). As shown in FIG. 2, the middleware 140 checks the response time of the backend 150 in act 210. The response time received is compared with a predetermined response time threshold in act 220. If the response time is not greater than the response time threshold, no bottleneck in the backend 150 has occurred and the processing of the client's request proceeds normally.

A preferred embodiment additionally includes the use of a non-responsiveness counter to prevent disabling of applications when only intermittent non-responsiveness occurs. The non-responsiveness counter is a counter stores a cumulative value in a given period. In this preferred embodiment, the period is one minute. The non-responsiveness counter is increased when the middleware determines that the response time is greater than the predetermined threshold in act 220. By comparing the non-responsiveness counter with a non-responsiveness counter threshold, the system can restrict disabling of an application only after a certain number of instances of non-responsiveness. Thus, in this preferred embodiment, the use of the counter will temper the likelihood of an application quiesce until a more significant back end bottleneck has occurred.

After the counter is increased by the middleware when the response time is greater than the threshold in act 240, the value of the counter is then compared with a counter threshold value in act 250. If the value stored in the counter is not greater than the counter threshold value, the client's request proceeds normally. If, however, the value stored in the counter is greater than the counter threshold value, the front end application requesting information from the back end is disabled (act 260). The threshold values represents the system tolerance for delay and may be appropriately adjusted depending upon the implementation. In one embodiment, the threshold value is a static value. Alternatively, the threshold value is dynamic and may be adjusted based on other parameters, such as time of day, etc.

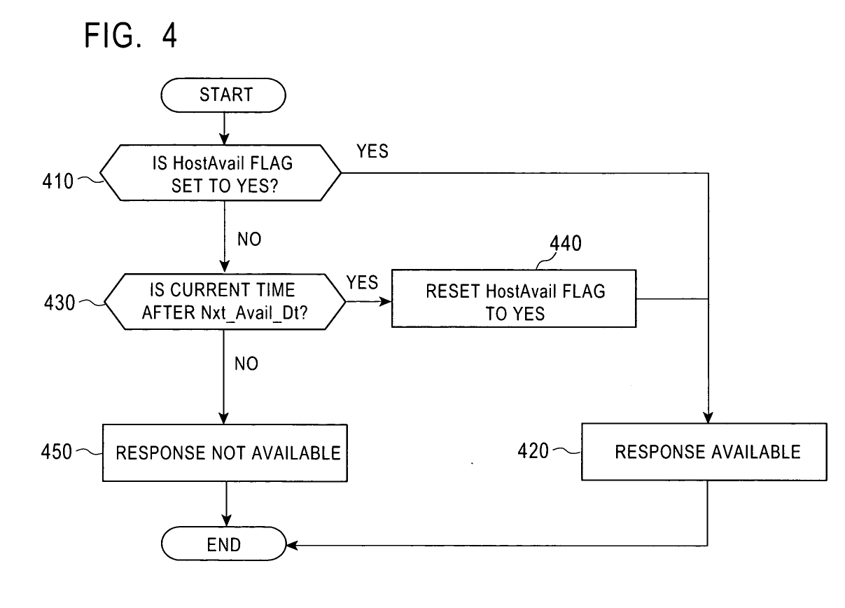

A flag indicating that the back end is not sufficiently responsive is then set and a next available date and time is stored (act 270). In this embodiment, the flag is referred to as a HostAvail flag. When set to yes, the HostAvail flag represents that the back end is sufficiently responsive. When set to no, the HostAvail flag represends that the back end is not sufficiently responsive. The default setting for the HostAvail flag is yes. As further explained with reference to FIG. 4 below, the next available date and time operates as a timer for the shutoff time of the front end application. In a preferred embodiment, the next available date and time is determined by adding a period of time, such as five minutes, to the middleware's current time. In act 280, the middleware sends a notification. In one embodiment, this notification occurs by way of a pager to a technician. Email, fax, or automated voice messages may be used in alternative embodiments. In yet further alternative embodiments, the notification may comprise an electronic notification sent another software component located in the server environment.

In the presently preferred embodiment, a user may still submit a request (such as a purchase request) even though the front end application may be quiesced. In this instance, the middleware will store the requested information and transmit the information to the back end once the bottleneck is resolved. In this embodiment, the user is given the choice between submitting the request and then checking back after a period of time to examine the result or refraining from submitting the request at all. In alternative embodiments, the buffering of requests may occur transparently to the requesting user or the user may be notified of a delay in the response.

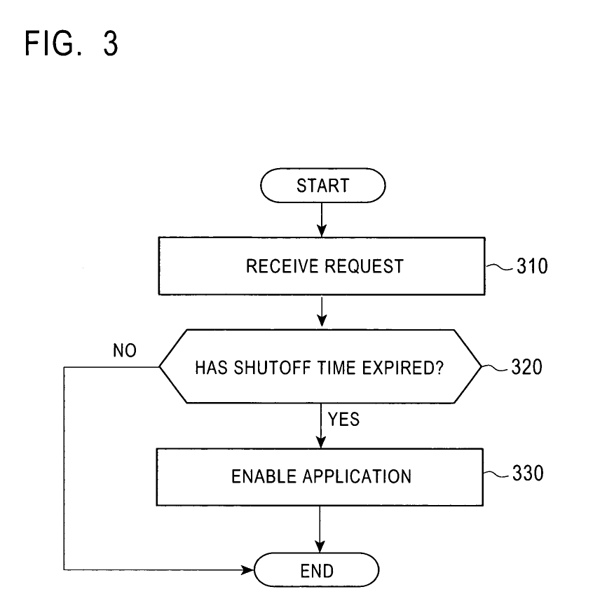

Once a front end application is quiesced, the middlware checks to see if the shutoff time has expired. If the shut off time has expired the front end is unquiesced. FIG. 3 generally shows this procedure according to one embodiment. The front end receives a request (act 310) from a client. The middleware then checks to see if the shutoff time has expired (act 320). If the stuff time has not expired, then the front end application remains quiesced. If the shut off time has expired, the application is unquiesced (act 330).

FIG. 4 depicts a flow chart showing the operation of the middleware in evaluating the ability to provide a response to a user according to one embodiment. The middleware checks the setting of the HostAvail flag (act 410). If the HostAvail flag is set to yes, the backend will be able to provide a response to the user and the middleware will conclude as such (act 420). If the HostAvail flag is set to no, the middleware compares the current date and time with the date and time stored as the next available date and time (Nxt_Avail_Dt) in act 430. If the current time is later than the next available date and time, the HostAvail flag is reset to ‘Yes’ in act 440. The middleware then concludes that the back end will be able to provide a response (act 420). If the current time is not later than the next available time, the middleware indicates that the a response is not available from the back end in act 450.

If a middleware concludes that a response is not available (act 450), the presently preferred embodiment will give the user the option of submitting its request anyway, wherein the middleware will store the information until the back end is sufficiently responsive and the user may check back later for the response to its request. In the alternative, the user may simply choose to submit its request at a later time. In other embodiments, the buffering of requests may occur transparently to the requesting user or the user may be notified of a delay in the response.

In alternative embodiments, the response time threshold, counter threshold, or both may use dynamic values (as opposed to static values). In these embodiments, either or both of the thresholds may be programmed to vary depending on time of day, load of the front end, back end or middleware, or of a variety of other variables as one of skill in the art would appreciate. In yet other alternative embodiments, the period of time in which an application is to be quiesced may also be determined dynamically according to time of day, load, or other variables.

Through the use of one of the disclosed embodiments, one can increase overall stability, responsiveness and throughput in the server environment. Additionally, hardware and server needs in supporting concurrent incoming request from a client are reduced.

It is therefore intended that the foregoing detailed description be regarded as illustrative rather than limiting, and that it be understood that it is the following claims, including all equivalents, that are intended to define the spirit and scope of this invention. It is to be understood the disclosed logic may be implemented in hardware, software, or a combination thereof.

1. A method of dynamically quiescing an application, said method comprising:
providing a server environment, said server environment operable to send requests and receive responses over a network and comprising a front end operative to execute a front end application for receiving a request and a back end operative to perform a task responsive to said request;
evaluating a back end response time for performing said task by said back-end;
comparing the back end response time with a response time threshold;
disabling a front end application for a period of time based on said act of comparing the back end response time with a response time threshold.

2. The method of claim 1 wherein the front end comprises a web server and the back end comprises a database.

3. The method of claim 2, wherein the server environment further comprises middleware.

4. The method of claim 3, wherein the front end comprises a plurality of web servers, the middlware comprises a plurality of application servers and the back end comprises a plurality of database servers.

5. The method of claim 1, wherein the front end comprises a plurality of web servers.

6. The method of claim 1 further comprising the act of increasing a counter when the response time has exceed the threshold response time; and comparing the counter with a counter threshold value.

7. The method of claim 6, wherein the counter threshold value is predetermined.

8. The method of claim 1 wherein the value of the threshold response time is predetermined.

9. The method of claim 1 wherein the value of the period of time is predetermined.

10. A system for dynamically quiescing an application, comprising:
a computer having a processor, a memory interface coupled with said processor, a memory coupled with said processor and said memory interface, a front end interface operable to communicate with a front end in a server environment, and a back end interface operable to communicate with a back end in the server environment;
a first logic stored in said memory and executable by said processor to receive first data via said back end interface, said first data comprising a back end response time;
a second logic stored in said memory and executable by said processor to receive second data via said memory interface, said second data comprising a back end response time threshold;
a third logic stored in said memory and executable by said processor coupled with said first and second logic and operative to compare said first data and said second data and generate a result indicating whether the value of the first data is greater than the value of the second data; and
a fourth logic stored in said memory and executable by said processor coupled with said third logic to send an instruction to disable an application operating on said front end by way of the front end interface based on said result.

11. The system of claim 10 further comprising:
a fifth logic stored in said memory and executable by said processor coupled with said third logic to maintain a cumulative value of instances in which the third logic has indicated that the value of the first data is greater than the value of the second data.

12. The system of claim 10 wherein said front end comprises one or more web servers.

13. The system of claim 10 wherein said back end comprises one or more database servers.

14. The system of claim 10 wherein said middleware comprises one or more application servers.

15. A system for dynamically quiescing an application, comprising:
means for communicating with a front end and back end in a server environment;
means for computing a backend response time;
means for comparing the backend response time with a backend response time threshold; and
means for disabling a front end application.

16. The system of claim 15 further comprising a means for maintaining a cumulative value of instances in which the back end response time is greater than the backend response time threshold.

17. The system of claim 15 further comprising a means for maintaining a cumulative value of instances in which the back end response time is greater than or equal to the backend response time threshold.
